(19) United States
(12) Patent Application Publication
(10) Pub. No.: US 2008/0318565 A1
(43) Pub. Date: Dec. 25, 2008

(54) Method and Apparatus for Assisting a Radio Communication Transfer in a Cellular Radio Communication System

(75) Inventors: Saso Stojanovski, Paris (FR); Claudiu Mihailescu, Versailles (FR); Pierre Lescuyer, Montigny Le Bretonneux (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, PARIS (FR)

(21) Appl. No.: 12/089,258

(22) PCT Filed: Oct. 6, 2006
(86) PCT No.: PCT/IB06/02790

§ 371 Date: Jul. 28, 2008

Related U.S. Application Data
(60) Provisional application No. 60/725,063, filed on Oct. 7, 2005.

(51) Int. Cl. H04Q 7/20

(52) U.S. Cl. 455/422.1

(57) ABSTRACT

The invention proposes a method for allowing radio communication transitions between packet and circuit switched modes in a cellular radio communication system comprising a core network, a first radio access network supporting a first mode among packet and circuit switched modes and a second radio access network supporting a second mode among packet and circuit switched modes. The first and second radio access networks include base stations covering respective cells, the base stations being capable of communications with mobile stations, an overlap existing between the cells of the first and second radio access networks, the method comprising the step of detecting and conditionally informing a mobile station, when the mobile station is in communication with a base station of the first radio access network covering a cell overlapping with another cell covered by another base station of the second radio access network.

### FIELD OF THE INVENTION

The present invention relates to assisting radio communication transitions, more specifically voice call continuity (VCC) transitions in radio communication systems.

### BACKGROUND OF THE INVENTION

The telecommunications world is now starting to migrate from circuit to packet switched connections, specifically voice over Internet protocol (VoIP) is starting to be more widely deployed and used in the fixed line world. The wireless domain has been working on to handle this migration to packet to deliver advanced multimedia applications and services. To this end it has been developed an architecture for the session initiation protocol (SIP) infrastructure known in 3^{rd} Generation Partnership Project (3GPP) as IP multimedia subsystem (IMS). This architecture is also being adopted in 3GPP2 under the name of mobile media distribution (MMD), and it is part of various Initiatives such as European Telecommunications Standards Institute (ETSI) telecoms & Internet converged services & protocols for advanced networks (TISPAN) in defining next generation networks in an access independent way.

The 3GPP IMS is a service infrastructure that enables operators to provide multimedia services. It defines a number of service support functions that provide session/service/quality of service (QoS) control, authentication, routing and interworking support, SIP compression, charging, etc. A detailed description of the 3GPP IMS is provided in the technical specification TS 23.228, version 7.4.0, entitled <<Technical Specification Group Services and System Aspects; IP Multimedia Subsystem (IMS); Stage 2 (Release 7)>>, published by the 3GPP In June 2006.

The IMS utilises an IP-connectivity access network (IP-CAN) to transport multimedia signalling and bearer traffic. An IP-CAN is a collection of network entities and interfaces that provides the underlying IP transport connectivity between a user equipment (UE) and the IMS entities. An example of IP-CAN is the global system for mobile communications (GSM)/enhanced data rates for GSM evolution (EDGE) radio access network (GERAN) core network with access network of type GERAN and/or UMTS terrestrial radio access network (UTRAN).

Most of the current cellular systems, in particular the UMTS systems, comprise on the one hand a core network and on the other hind one or more radio access networks. The UMTS core network comprises two distinct domains, the circuit switched (CS) domain and the packet switched (PS) domain, in order to differentiate between the circuit switched services and the packet switched services. Some functions, such as a call setup, are handled differently and implemented in different core network nodes according to the domain in which they are completed.

There is currently an ongoing specification work in 3GPP on the provision of continuity for the voice service (voice call continuity feature, VCC) between the CS domain and the IMS. The feasibility study on the voice call continuity between the IMS and CS domains is contained in the technical report TR 23.806, version 7.0.0, entitled “Voice Call Continuity between CS and IMS Study (Release 7)”, published by the 3GPP in December 2005. The VCC work addresses a variety of transition situations for the continuity of a voice call provided by either the PS or the CS domain, while supported by either intelligent wireless local area network (I-WLAN), 2G (GERAN) or 3G (UTRAN) access networks. The issue of transitioning between different access technologies for a voice call handled in either the PS or the CS domain has been addressed in prior work. The 3GPP TR 23.806 focuses on transitions in the “dual radio” case e.g. between IMS accessed over WLAN and a 2G CS or 3G CS domain. The same document provides a high-level description of two methods for the “single radio” case (e.g. 3G PS to 2G CS voice continuity), but both of them are incomplete. Only the “dual radio” case has later been specified in the technical specification 3GPP TS 23.206. The present invention addresses a possible completion of the two methods for the “single radio” case proposed in TR 23.806.

The TR 23.806 provides two methods for achieving a 3G PS to 2G CS voice mobility transition. A first method, also known as a “combinational” approach, described in section 6.3.8 of the technical report, combines a VCC domain transfer from 3G PS to 3G CS, i.e. the voice call is transitioned on a different CN domain while serviced by the same access technology. This is followed by a classical radio access handover in order to transition from 3G CS to 2G CS. Classical handover procedures are used to transition active voice calls when roaming within the same domain. In a second method, referred to as CReDT (Call Reestablishment on Domain Transfer), described in Annex E of the technical report, the voice call is parked prior to releasing the source (3G) radio resources, establishing the target (2G) radio resources and re-establishing the voice service in the CN CS domain.

The same principles also apply when transitioning a voice call for instance from a long term evolution network (LTE) PS to 3G CS. In this case, if the combinational approach is used, a classical handover is first performed from LTE PS to 3G PS and then a VCC domain transfer from 3G PS to 3G CS. Also the CReDT procedure is applicable, in which case the voice call is parked while in the LTE PS and unparked after the re-establishment of a 3G CS access leg. Also transitions from LTE PS to 2G CS are possible by using either of the combinational VCC (provided there is a support for VoIP radio bearers on the 2G PS side) or the CReDT procedure. Transitions to a reverse direction are also possible.

Both of the above described approaches have their advantages and drawbacks. For instance the combinational VCC allows for seamless transitions, but cannot be applicable to all scenarios. On the other hand, the CReDT causes a perceptible service break, but may cover scenarios where the combinational approach is not applicable.

Using such transition schemes requires the definition of control procedures, and in particular triggers, which can be operated either by the network or by a terminal, also known as a user equipment (UE) or a mobile station (MS). Trigger control procedures define how either a terminal or the network may decide to request the re-establishment of an active voice service to a different CN domain and/or with a different radio access technology. Such trigger can be, for instance, based on the detection of a radio link failure situation.

However, in case there is no radio link failure, the UE may not have sufficient information in order to trigger the VCC domain transfer. For instance, the mobile station may not know whether there is a 2G cell suitable for being a target cell for a VCC procedure. This will typically be the case if the so-called compressed mode has not been activated in the 3G wireless network. Also, even though the mobile station may be aware of the presence of a suitable 2G target cell, it may not know whether or not the 2G target cell supports a VoIP bearer service. It is also possible that there is another radio access network in the vicinity that would offer, for instance, better quality of service, but the UE is not aware of this. Thus, the UE may not know when to initialise the VCC domain transfer.

An object of the present invention is to offer a control scheme for a voice call transition.

### SUMMARY OF THE INVENTION

The invention thus proposes a method for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the method comprising the step of detecting and conditionally informing a mobile station, when the mobile station is in communication with a base station of the first radio access network covering a cell overlapping with another cell covered by another base station of the second radio access network.

The invention according to an embodiment has the advantage that when it has been detected that the mobile station is capable of transferring a radio communication between the packet switched mode and circuit switched mode, the mobile station is informed, required that a certain condition is fulfilled, that it is located in a special cell and thus a radio communication transition to the second access network is supported by the system. Thus, the radio communication transition procedure is improved so that the mobile station is informed when it is advantageous to transfer a connection to another access network.

The invention also proposes a computer program product for implementing any of the method steps when loaded and run on computer means of the system.

The invention also proposes a radio network controller for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the radio network controller comprising means for detecting and conditionally informing a mobile station, when the mobile station is in communication with a base station of the first radio access network covering a cell overlapping with another cell covered by another base station of the second radio access network.

The invention also proposes a mobile station for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the mobile station comprising:

means for sending an indication to the first access network that the mobile station is capable of performing a transition between packet and circuit switched modes; and

means for receiving an indication, conditionally transmitted by the base station of the first access network informing the mobile station, when the mobile station is in communication with a base station of the first radio access network covering a cell overlapping with another cell covered by another base station of the second radio access network.

The invention also proposes a cellular radio communication system including means for implementing a method according to the embodiments of the invention.

The features of the above aspects which are indicated by the dependent claims may be combined as appropriate, and may be combined with any of the above aspects of the invention, as would be apparent to a person skilled in the art.

### BRIEF DESCRIPTION OF THE DRAWINGS

Other features and advantages of the invention will become apparent from the following detailed description of some non-limiting exemplary embodiments, with reference to the appended figures, in which:

FIG. 1 shows a general diagram of a cellular radio communication system architecture to which the invention can be applied; and

FIG. 2 shows a flow chart illustrating the method according to an embodiment of the invention.

### DETAILED DESCRIPTION OF EMBODIMENTS OF THE INVENTION

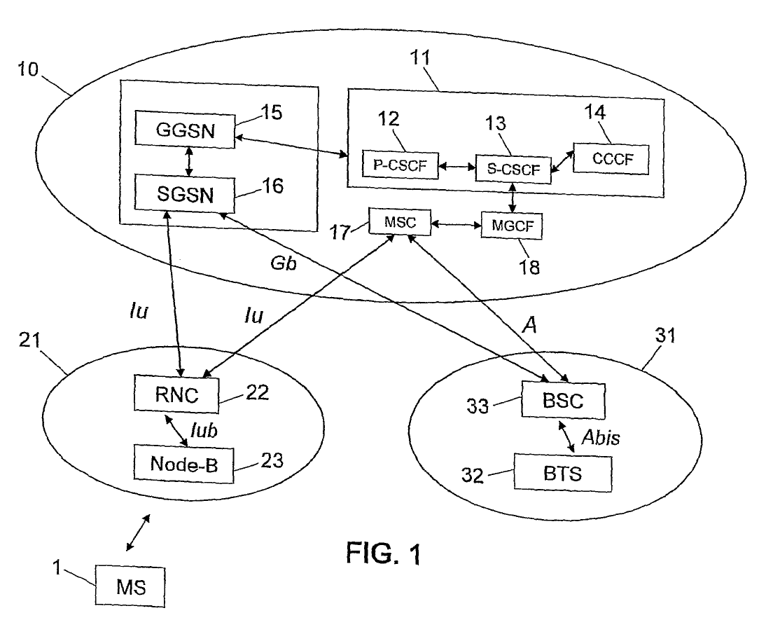

The cellular radio communication system shown in FIG. 1 comprises a cellular network with extensive coverage, e.g. national, managed by a general public operator.

This public land mobile network (PLMN) is conventionally divided into a core network 10, comprising interconnected switches, and two access networks 21, 31, namely a UMTS (3G) radio access network 21 and a GSM (2G) access network 31 providing the radio links with the mobile radio terminals 1.

The core network 10 is connected to fixed networks comprising a public switched telephone network (PSTN) and one or more packet transmission networks using respective protocols (PDP, Packet Data Protocol) such as X.25 or IP.

The core network 10 comprises a GERAN core network, which includes in the packet domain intermeshed switches, called GPRS support nodes (GSNs), which communicate with one another through a standardised interface called Gn. We distinguish between gateway GSNs 15 (GGSNs) which serve as gateways with external networks such as the Internet for example, and serving GSNs 16 (SGSNs) which are linked to a UTRAN through an interface called Iu. The GERAN core network includes in the CS domain mobile switching centres (MSCs) 17 combined with visitor location registers (VLRs). These MSCs 17 ensure circuit switching for circuit mode telephone or data transfer communications. Some MSCs (G-MSCs) act as a gateway with the fixed networks, especially with the PSTN. The MSC 17 is connected to the GSM radio access network 31 via an interface called A.

The core network 10 also includes an IM CN subsystem 11, which comprises IMS entities and can be seen from an architectural viewpoint as an overlay to the GERAN core network architecture. FIG. 1 illustrates an IMS Proxy-CSCF node 12 (P-CSCF) which is the first contact point within the IM CN subsystem 11. Its address is discovered by the mobile stations 1, and it behaves as a SIP “Proxy” and may behave as a SIP “User Agent”. Both SIP functions are described in the SIP specification RFC 3261, <<SIP: Session Initiation Protocol>>, published by the Internet Engineering Task Force (IETF) in June 2002. The Serving-CSCF (S-CSCF) node 13 performs the IMS session control services for the mobile station, and maintains an IMS session state as needed by the network operator for support of the services. The functions performed by an S-CSCF during an IMS session are: registration, session-related and session-unrelated flows, SIP signalling vis-à-vis a destination endpoint, and generation of charging data records (CDR).

The SIP is an application layer signalling protocol, specified in the RFCs 2543 and 3261. SIP specifies client and server entities, and procedures for initialising a communication between such entities. Two types of SIP servers are specified: proxy servers and redirection servers. Upon receipt of a request, a proxy server identifies the next node in the path towards the destination, and forwards the request to the identified node, whereas a redirection server merely indicates to the client the next node to which the request should be sent. SIP addresses are similar to electronic mall addresses, and are of the user@host form, wherein the “user” field designates for instance a user name or a phone number, and the “host” field a domain name or an address. The SIP protocol includes inter alia methods, called INVITE, BYE, REGISTER, OPTIONS and CANCEL. Responses to sent messages that correspond to these methods are defined by codes. The INVITE method is used to initialise a call session between two SIP users. The SIP protocol also provides some mobility features, and allows for a user to access services notwithstanding its location or the device/terminal used with a SIP client, thanks notably to the REGISTER methods.

Also shown in FIG. 1 in the IM CN subsystem 11 is a call continuity control function (CCCF) node 14 which provides functions for call continuity between the CS domain and IMS entities using an IP connectivity access network such as the GERAN core network 10. Further details on the functions provided by the CCCF entity can be found in section 6.2.1 of the 3GPP TR 23.806 version 7.0.0.

The IM CN subsystem 11 also includes an application server (AS) which provides multimedia services, and interacts with one or several multimedia resource function nodes to ensure delivery of multimedia services. The architecture of the multimedia resource function is provided in the 3GPP technical specification TS 23.228.

In the example shown, the PLMN is a third generation network of the UMTS type, and incorporates a 2G, GSM type access network (GERAN) 31, and a 3G, UMTS type access network, UTRAN. The UTRAN is the most common access network for UMTS systems, and is composed of controllers called radio network controllers (RNCs) and of base stations called “Node B” distributed over the zone of coverage of the access network and each controlled by one of the RNCs. In FIG. 1 there is shown a UTRAN 21 which comprises a certain number of RNCs 22, some of which are linked to a SGSN of the GERAN core network 10 and/or to an MSC 17 of the GERAN core network 10 through a so-called Iu interface (a single RNC is represented in FIG. 1). In FIG. 1 there is also shown a media gateway control function (MGCF) block 18, which is connected to the MSC 17 and to the S-CSCF node 13. The MGCF is a signalling gateway functionality between the CS domain and the IMS. Each RNC controls one or more nodes B 23 through a so-called interface Iub. The radio interface between a node B 23 and a UMTS terminal 1 (mobile station) is called Uu.

Also shown in FIG. 1 is a GSM access network 31, composed of base transceiver stations (BTS) 32 distributed over the 3G network coverage area for communicating by radio with mobile terminals, and base station controllers (BSC) 33 connected to the GERAN core network 10 and each monitoring the base stations 32 via so-called Abis interfaces. In this example, the GSM access network 31 does not support VoIP calls. The cells defined by the BTSs 32 of the GSM access network 31 can form umbrella cells with respect of cells defined by the Nodes-B 23.

The invention is also applicable to other types of PLMNs, such as fourth generation (4G) networks, also known LTE networks.

The mobile station 1 includes means for communicating with 3G UMTS equipments, and is as such a UMTS terminal. It also includes means for communicating with 2G GSM equipments, and is as such also a GSM terminal. When in communication, for instance with a remote terminal, the communication is advantageously performed using 3G wireless equipments of the telecommunication system. Such 3G equipments comprise at least a 3G base station (that is a UMTS Node-B) 23 which is in communication with the UMTS terminal 1 via a radio interface. Such 3G equipments also include an RNC 22 which controls the Node-B 23 and the communication involving mobile station 1. The 3G equipments also comprise, in the GERAN core network, a 3G switch, which may be either a mobile switching centre (MCS), if the communication is in circuit mode (CS domain), or an SGSN if the communication is in packet mode (PS domain), with which the RNC 22 communicates.

A communication involving the mobile station 1, and a distant terminal, is therefore served through the above described 3G equipments as well as other equipments in the system with which the distant terminal (remote party) communicates.

In the following we assume that a point to point voice communication between the mobile station 1 and another terminal takes place, using 3G equipments, in PS mode. This voice communication may be a voice over IP communication, and it is also assumed that It Involves entities in the IM CN subsystem 11.

The call setup process in the UMTS PS domain uses the concept of PDP context. A PDP context is a communication session context, which may be defined as a collection of information relating to a communication session. More specifically, the PDP context contains the information necessary for transmitting the user information between the mobile, the UMTS network, and an external packet data network. Before initiating a transfer of data, the mobile station 1 requests from the core network the activation of a PDP context. The core network will proceed with verifying that the attributes of the requested PDP context comply with the user subscription. Several PDP contexts can be simultaneously active for a given user. A user may indeed want to activate several concurrent sessions, e.g. in order to simultaneously check two electronic mailboxes hosted by different Internet access providers. In such a case, the mobile station 1 must activate as many PDP contexts as it needs concurrent communication sessions.

The voice communication makes use of the radio interface between the mobile station 1 and the Node-B 23. The RNC 22 controls radio resources, including the radio resources allocated to the mobile station 1, according to the radio resource control (RRC) described in the technical specification TS 25.331, version 7.1.0, published in June 2006 by the 3GPP. In particular, the RNC 22 should detect the occurrence of specific radio conditions on the radio link between the mobile station and the Node-B 23, so as to trigger a process for transferring the communication on other resources, also referred to as a “handover” process.

In order to trigger the handover process, both the mobile station 1 and the Node-B 23 carry out radio measurements that include for instance field levels on the uplink and downlink between the mobile station 1 and the Node-B 23, field levels on the downlinks from neighbouring cells, as well as other measurements (see section 8.4 of the above-mentioned TS 25.331).

A handover process will typically be triggered by an RNC when measurements are completed by the base station and the mobile station show that a condition for transferring the communication is met. This can be the case when the radio field level or the estimated quality level of the radio link between the mobile station and the base station is too low.

In accordance with an embodiment of the invention, a new terminal capability c is defined for the mobile station 1. This particular capability c is defined for all VCC capable mobile stations 1.

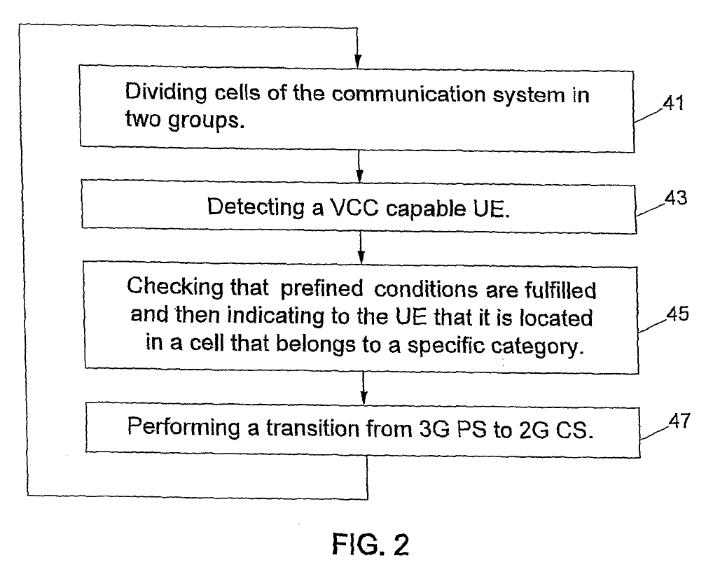

In the UTRAN 21 certain cells are configured as special cells with respect to the mobile stations 1 having the above-identified capability c. The cells are defined by the Nodes-B 23 (or BTSs 32) so that each Node-B typically defines one to three cells. A cell is the geographical area covered by a base station transmitter. In the coverage area of the cell, radio signal strength is sufficiently strong for a mobile station to keep up a reliable radio transmission with the respective base station transmitter. Accordingly, the cells in the UTRAN 21 can be divided, in step 41 of FIG. 2, into two categories, namely into cell categories A and B. In this example, the cells belonging to the category A are defined to be normal cells and the cells belonging to the category B have special characteristics with respect to the mobile stations having the capability c.

Possible candidates for the category B are the 3G cells located at the edge of a contiguous 3G coverage area. Thus it would be advantageous that the RNC 22 knows which of the cells are so called border cells between two different radio access networks. In the category B cells, the mobile stations 1 are capable of receiving signals transmitted from the base BTSs 32 of the GSM access network 31. But there can also be cells classified to the category B in the middle of the contiguous coverage area of the 3G area, if for instance a received signal strength from the Node-B 23 in that particular cell is constantly too low. Thus the criterion for classifying the cells to the category B can be based on received signal strengths from different radio access networks.

Then in step 43, the radio communication system, more specifically the RNC 22, detects whether the mobile station 1 that communicates with the Node-B 23 is capable of transferring a voice connection between an IMS and a CS network. In other words, the RNC 22 detects whether the mobile station 1 currently communicating with the Node-B 23 is a VCC-capable terminal. RRC messages capable of carrying the terminal capability information from the mobile station 1 to the RNC 22 are for instance RRC CONNECTION SETUP COMPLETE or UE CAPABILITY INFORMATION messages.

When it has been determined by the RNC 22 that the mobile station 1 currently communicating with the Node-B 23 is indeed a VCC-capable terminal, then the RNC 22 determines in step 45 whether a certain condition is fulfilled and if this is the case, then indicating to the mobile station 1 that it is located in a special cell, in this example in a cell B. The condition mentioned above can be, for instance a geographical location of the mobile station with respect to the cell coverage area of a cell classified as belonging to the category B. The RNC 22 can detect the location of the mobile station 1 by for instance listening to measurement reports from the mobile stations 1.

Accordingly, in this example the mobile station 1 is informed that it is located in a coverage area of a cell that belongs to the category B. In this example only the 3G cells that can operate in a CS mode can be classified to the category B. A further predefined condition can be set so that only when all these conditions are fulfilled, the mobile station 1 is informed that it is located in a coverage area of a special cell B. Examples of these kinds of conditions are a received signal strength Indicator at the Node-B 23 or other signal strength or quality indicators. The Node-B 23 can send this information to the mobile station 1 for instance in a UTRAN MOBILITY INFORMATION message. This message can be sent to the mobile station 1 any time by the Node-B 23 to provide the mobile station 1 with new information. The UTRAN MOBILITY INFORMATION message may further indicate to the mobile station 1 that in its current location, a voice call transition from 3G PS to 2G CS is possible and would be advantageous.

Now the mobile station 1 is made aware of the special cells B so that the responsibility of the interpretation of the information received from the RNC 22 is left to the applications in the mobile station 1. If the mobile station 1 decides that a voice call transition should be done, then the mobile station 1 can start in step 47 the procedure of transferring the voice call connection to the CS domain of the 2G network. The transition can either follow the principles of the combinational VCC method or the CReDT method as was described earlier. With reference to FIG. 1, the mobile station 1 that is initially in radio communication with the Node-B 23 performs in step 47 a voice call transition to the cell defined by the BTS 32. In this example the 2G BTS 32 does not support a VoIP bearer service for a voice communication.

In accordance with a second embodiment of the invention, the mobile station is initially in the 3G cell in a CS connection and performs a voice call transition to an LTE network, such as a 4G network to operate in PS mode.

This embodiment follows the principles of the first embodiment described above. In case of the combinational VCC approach, the mobile station 1 first performs a VCC domain transfer to 3G PS and then conventional handover to LTE PS. In this embodiment the cells that are classified to belong to a special category B, are advantageously 3G cells at the edge of the 3G and LTE coverage. Again, the network detects that the mobile station is a VCC capable terminal. If certain conditions, as was explained in relation to the first embodiment, are fulfilled, the network informs the mobile station 1 that a voice call transition may be successfully performed.

The mechanism described above can be generalised to apply for future applications in the mobile stations that would benefit from being warned that they are located in a special cell.

The functions described in the present document may be implemented in one or several network entities or devices, and the present invention is not limited to implementation of each function in a corresponding, separate, physical network entity, apparatus or node. Interfaces designed and specified between two functions so that said functions may interoperate or cooperate with each other may be logical interfaces, for instance when both functions are implemented in the same physical node.

The invention equally relates to a corresponding computer program product that is arranged to implement any of the steps of the method described above, when loaded and run on the computer means of the radio communication network.

The invention equally relates to the radio communication system in which the teachings of the embodiments of the invention can be applied.

The invention equally relates to a mobile station which is arranged to implement at least some of the method steps described above.

The invention equally relates to a radio network controller which is arranged to implement at least some of the method steps described above.

1. A method for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the method comprising the step of detecting and conditionally informing a mobile station, when the mobile station is in communication with a base station of the first radio access network covering a cell overlapping with another cell covered by another base station of the second radio access network.

2. The method according to claim 1, wherein the mobile station further indicating to the radio communication network that it is capable of transferring a voice call between the packet and circuit switched modes.

3. The method according to claim 1, wherein conditionally comprises detecting that a received signal strength measured at the base station with which said mobile station is communicating drops under a certain threshold.

4. The method according to claim 1, wherein the method further comprises initiating a transition between the packet and circuit switched modes so that the radio communication continues with another base station of the second radio access network.

5. The method according to claim 1, wherein said first access network is a 3G cellular access network, and the second access network is a 2G cellular access network.

6. The method according to claim 1, wherein the mobile station is initially in a voice over internet protocol communication in the first access network.

7. The method according to claim 4, wherein the mobile station is after the transition in a circuit switched connection with the base station of the second access network.

8. The method according to claim 1, wherein said first access network is a 3G cellular access network, and the second access network is an LTE cellular access network.

9. The method according to claim 1, wherein the mobile station is initially in a circuit switched communication in the first access network.

10. The method according to claim 4, wherein the mobile station is, after the radio connection has been transferred to the second access network, in a voice over Internet protocol communication with the base station of the second access network.

11. A computer program product for implementing any of the steps of the method of claim 1 when loaded and run on computer means of the system.

12. A radio network controller for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the radio network controller comprising means for detecting and conditionally informing a mobile station, when the mobile station is in communication with a base station of the first radio access network covering a cell overlapping with another cell covered by another base station of the second radio access network.

13. A mobile station for allowing radio communication transitions between packet and circuit switched modes in a cellular radio communication system comprising a core network, a first radio access network supporting a first mode among packet and circuit switched modes and a second radio access network supporting a second mode among packet and circuit switched modes, the first and second radio access networks including base stations covering respective cells, the base stations being capable of communications with mobile stations, an overlap existing between the cells of the first and second radio access networks, the mobile station comprising:
means for sending an indication to the first access network that the mobile station is capable of performing a transition between packet and circuit switched modes; and
means for receiving an indication, conditionally transmitted by the base station of the first access network informing the mobile station, when the mobile station is in communication with a base station of the first radio access network covering a cell overlapping with another cell covered by another base station of the second radio access network.

14. A cellular radio communication system including means for implementing the method according to claim 1.
